(19) United States
(12) Patent Application Publication
(10) Pub. No.: US 2010/0263553 A1
(43) Pub. Date: Oct. 21, 2010

(54) Grilling Apparatus and Methods of Making and Using the Same

(76) Inventor: Allen Nemeth, Lake in the Hills, IL (US)

Correspondence Address: SCHERRER PATENT & TRADEMARK LAW P.C., 17 E. CRYSTAL LAKE AVE, CRYSTAL LAKE, IL, 60014, US

(21) Appl. No.: 12/692,766

(22) Filed: Jan. 25, 2010

Related U.S. Application Data
(60) Provisional application No. 61/170,323, filed on Apr. 17, 2009.

(51) Int. Cl. A47J 37/00

(52) U.S. Cl. 99/422

(57) ABSTRACT

An apparatus made from stone, ceramic, clay, fire clay or other like materials has a smooth surface on a first side and a textured surface on a second side. At least one of the first side and the second side has a depressed area for the retention of water and/or cooking oils to aid in the grilling and/or cooking of foods disposed thereon. In addition, the apparatus is generally rectangularly-shaped with at least one side being arcuate to effect heat distribution evenly around the edges of the apparatus and to aid in fitting the apparatus on a grilling surface of a modern grill.

### CROSS-REFERENCE TO RELATED APPLICATIONS

The present invention claims priority to U.S. Provisional Patent Application No. 61/170,323 filed Apr. 17, 2009, the content of which is incorporated herein in its entirety.

### BACKGROUND OF THE INVENTION

The present invention generally relates to a grilling apparatus and methods of making and using the same. More specifically, the present invention relates to a grilling apparatus having a smooth surface on a first side and a textured surface on a second side. Moreover, the present invention relates to a grilling apparatus wherein at least one of the first side and the second side has a depressed area for the retention of water, cooking oils, food products and the like to aid in the grilling of foods disposed thereon. In addition, the grilling apparatus is generally rectangularly-shaped with rounded, arcuate edges to effect heat distribution evenly around the edges of the grilling apparatus and to fit modern grills.

It is, of course, generally known to provide a grilling surface for the cooking of foods. Since the dawn of humankind, people have cooked foods over open flames. In addition, it is generally known to provide a cooking surface for disposing of one or more food products for the cooking thereof.

However, many times, surfaces utilized for the grilling or cooking of foods do not distribute heat evenly. Moreover, many surfaces for grilling or cooking of foods do not allow for easy removal of the cooked food products without sticking of the food product to the surface.

Further, grills utilized for the cooking of foods thereon typically have wire racks for the holding of the food products as they cook over flame, such as via charcoal and/or propane. Smaller-sized foods may have a tendency to fall through the spaces in the grill racks, whereupon foods may be consumed by the flames and lost.

Still further, wire racks typically utilized for cooking food products on a grill or over an open flame allow juices and/or oils from the food products to drip down onto the flames causing flare-ups that can scorch or char the food product being cooked.

In addition, typical surfaces utilized for the grilling or cooking of foods do not allow for water to be utilized as a cooking medium, such as in the steaming of foods thereon to maintain the moisture content of foods. In addition, typical surfaces utilized for the grilling or cooking of foods do not allow for the retention of fats and oils as a cooking medium, such as in the frying of foods. Still further, typical surfaces utilized for the grilling or cooking of foods do not allow for both the ability to provide a smooth surface for the easy removal of cooked food products without sticking, and a textured surface for the retention of water and/or fats and oils as cooking media for foods cooked thereon.

Moreover, in many instances, surfaces utilized for the grilling or cooking of foods are not shaped appropriately to allow convection heat to rise around the edges of the cooking surfaces to both cook a food by both a direct heat source (from the surface of the grilling apparatus) and an indirect heat source (via convection heat). Still further, typical surfaces utilized for the grilling or cooking of foods are not shaped appropriately to fit on grill racks of many modern grills.

Further, many surfaces utilized for the grilling or cooking of foods retain residual odors and impart tastes to foods subsequently cooked thereon.

A need, therefore, exists for a grilling apparatus and methods of making and using the same having a smooth surface for easily cooking foods thereon. A need exists for a grilling apparatus and methods of making and using the same having at least a first side having a smooth surface whereby food is easily removed therefrom after cooking.

In addition, a need exists for a grilling apparatus and methods of making and using the same wherein smaller-sized food products will not fall into open flames and be consumed by the flames. Moreover, a need exists for a grilling apparatus and methods of making and using the same wherein juices, oils and the like are prevented from dripping into open flames causing flare-ups, and wherein food products are protected from being scorched or charred in the event flare-ups occur.

Further, a need exists for a grilling apparatus and methods of making and using the same having at least a textured surface for cooking foods, whereby water and/or oils may be disposed within the texture of the textured surface to entrap the water and/or oil to more easily cook one or more food products within the water and/or oil.

Moreover, a need exists for a grilling apparatus and methods of making and using the same having a depressed area on at least one of the sides of the grilling apparatus whereby water and/or oils may be further entrapped, thereby aiding in the cooking of the one or more food products within the water and/or oil.

In addition, a need exists for a grilling apparatus and methods of making and using the same made from stone, clay, ceramic, and fire clay for the even distribution of heat therethrough for the cooking of one or more food products thereon.

Still further, a need exists for a grilling apparatus and methods of making and using the same having a generally square or rectangular shape having at least one arcuate side to aid in fitting the grilling apparatus within modern grills and for aiding in the distribution of convection heat around the grilling apparatus to aid in cooking the one or more food products.

In addition, a need exists for a grilling apparatus and methods of making and using the same whereby residual odors may be easily removed therefrom, and from which residual tastes are not imparted to foods subsequently cooked thereon.

### SUMMARY OF THE INVENTION

The present invention generally relates to a grilling surface and methods of making and using the same. More specifically, the present invention relates to a grilling apparatus having a smooth surface on a first side and a textured surface on a second side. Moreover, the present invention relates to a grilling apparatus wherein at least one of the first side and the second side has a depressed area for the retention of water and/or cooking oils to aid in the grilling of foods disposed thereon. In addition, the grilling apparatus is generally rectangularly-shaped with rounded, arcuate edges to effect heat distribution evenly around the edges of the grilling apparatus and to fit modern grills.

To this end, in an embodiment of the present invention, an apparatus for cooking food thereon is provided. The apparatus comprises a slab made of hardened clay having a first end and a second end, a first side having a first surface and a second side having a second surface wherein the second surface has a texture of bumps and pits, and wherein the slab has a thickness between the first surface and the second surface, and further wherein the slab has a raised portion disposed about an outside edge of the second side wherein the raised portion has a top surface and further wherein the raised portion has a thickness between the top surface of the raised portion and the first surface of the first side, wherein the thickness between the top surface of the raised portion and the first surface is greater than the thickness between the first surface and the second surface.

In an embodiment, the first end is arcuate in shape.

In an embodiment, the first end and the second end are arcuate in shape.

In an embodiment, the thickness between the first surface and the second surface is constant over the entirety of the slab.

In an embodiment, the top surface of the raised portion has a width measured from the outside edge of the second side to the second surface, wherein the width of the top surface of the raised portion is constant over the entirety of the slab between the outside edge of the second side to the second surface.

In an embodiment, the thickness between the first surface and the second surface is between about ¼ inch and about 1 inch.

In an embodiment, the difference in the thickness of the raised portion and the thickness between the first surface and the second surface is between about 1/32 inch and about ⅛ inch.

In an alternate embodiment of the present invention, a system for cooking food is provided. The system comprises a hardened clay slab for cooking food thereon comprising a first side having a first surface, a second side having a depression for holding food products therein, wherein the depression has a bottom surface and said bottom surface has a texture of pits and bumps, and a thickness between the first side and the second side; and a heating device wherein the apparatus is disposed on the heating device.

In an embodiment, the heating device is selected from the group consisting of a grill, an oven, or a stove-top.

In an embodiment, the slab further comprises a first end wherein the first end is arcuate in shape.

In an embodiment, the slab further comprises a first end and a second end wherein the first end and the second end are both arcuate in shape.

In an embodiment, the depression of the slab has a depth wherein the depth of the depression is constant over the entirety of the depression.

In an embodiment, the slab has a thickness of between about ¼ inch and about 1 inch.

In an embodiment, the depression has a depth between about 1/32 inch and about ⅛ inch.

In an alternate embodiment of the present invention, a method of using an apparatus for cooking food is provided. The method comprises the steps of: providing a slab made of hardened clay having a first end and a second end, a first side having a first surface and a second side having a second surface wherein the second surface has a texture of bumps and pits, and wherein the slab has a thickness between the first surface and the second surface, and further wherein the slab has a raised portion disposed about an outside edge of the second side wherein the raised portion has a top surface and further wherein the raised portion has a thickness between the top surface of the raised portion and the first surface of the first side, wherein the thickness between the top surface of the raised portion and the first surface is greater than the thickness between the first surface and the second surface; disposing a food product on a side selected from the group consisting of the first side and the second side; disposing a heat source beneath the slab; and cooking the food product on the slab.

In an embodiment, the food product is disposed on the second surface.

In an embodiment, the method further comprises the steps of adding a liquid cooking medium to the second surface; and disposing a food product on the second surface in the liquid cooking medium.

In an embodiment, the method further comprises the steps of adding a liquid cooking medium to the depression of the second side, wherein the cooking medium is selected from the group consisting of water and oil; and disposing a food product on the second surface in the liquid cooking medium.

In an embodiment, the heat source is selected from the group consisting of a grill, an oven and a stove-top.

In an embodiment, the method further comprises the steps of providing a lid; and disposing the lid over the food product when cooking the food product.

It is, therefore, an advantage of the present invention to provide a grilling apparatus and methods of making and using the same. Specifically, it is an advantage of the present invention to provide a grilling apparatus and methods of making and using the same, wherein the grilling apparatus has at least a smooth surface for easily cooking foods thereon.

Further, it is an advantage of the present invention to provide a grilling apparatus and methods of making and using the same, wherein the grilling apparatus does not include spaces such as a grilling rack or the like where food products can fall through to be consumed by the flames below. Moreover, it is an advantage of the present invention to provide a grilling apparatus and methods of making and using the same, wherein the grilling apparatus protects foods from flames and/or flare-ups that may be generated by dripping juices and/or oils from the food products.

Moreover, it is an advantage of the present invention to provide a grilling apparatus and methods of making and using the same wherein the grilling apparatus has a first side having a smooth surface whereby food is easily removed therefrom after cooking.

Further, it is an advantage of the present invention to provide a grilling apparatus and methods of making and using the same wherein the grilling apparatus has at least a textured surface for cooking foods, whereby water and/or oils may be disposed within the texture of the textured surface to entrap the water and/or oil to more easily cook one or more food products within the water and/or oil.

Moreover, it is an advantage of the present invention to provide a grilling apparatus and methods of making and using the same wherein the grilling apparatus has a depressed area on one of the sides of the grilling apparatus whereby water and/or oils may be further entrapped, thereby aiding in the cooking of the one or more food products within the water and/or oil.

In addition, it is an advantage of the present invention to provide a grilling apparatus and methods of making and using the same wherein the grilling apparatus is made from stone, clay, ceramic, fire clay, or other like materials for the even distribution of heat therethrough for the cooking of one or more food products thereon.

Still further, it is an advantage of the present invention to provide a grilling apparatus and methods of making and using the same wherein the grilling apparatus has a generally square or rectangular shape having at least one arcuate side to aid in fitting the grilling apparatus within modern grills and for aiding in the distribution of convection heat around the grilling apparatus to aid in cooking the one or more food products.

In addition, it is an advantage of the present invention to provide a grilling apparatus and methods of making and using the same whereby residual odors may be easily removed therefrom, and from which residual tastes are not imparted to foods subsequently cooked thereon.

Additional features and advantages of the present invention are described in, and will be apparent from, the detailed description of the presently preferred embodiments and from the drawings.

### BRIEF DESCRIPTION OF THE DRAWINGS

FIG. 1 is a perspective view of a grilling apparatus in an embodiment of the present invention.

FIG. 2 illustrates a plan view of a first side of an apparatus for cooking food thereon in an embodiment of the present invention.

FIG. 3 illustrates a plan view of a second side of an apparatus for cooking food thereon in an embodiment of the present invention.

FIG. 4 illustrates a cross-sectional view of an apparatus for cooking food thereon in an embodiment of the present invention.

FIG. 5 illustrates a perspective view of an apparatus for cooking food thereon disposed on a grill rack and a food product cooking thereon in an embodiment of the present invention

FIG. 6 illustrates a method of making a grilling apparatus in an embodiment of the present invention.

### DETAILED DESCRIPTION OF THE PRESENTLY PREFERRED EMBODIMENTS

The present invention generally relates to an apparatus for cooking and/or grilling, food and methods of making and using the same. More specifically, the present invention relates to an apparatus having a smooth surface on a first side and a textured surface on a second side. Moreover, the present invention relates to an apparatus wherein at least one of the first side and the second side has a depressed area for the retention of water and/or cooking oils to aid in the grilling of foods disposed thereon. In addition, the apparatus is generally rectangularly-shaped with rounded edges to effect heat distribution evenly around the edges of the grilling apparatus and to fit modern grills.

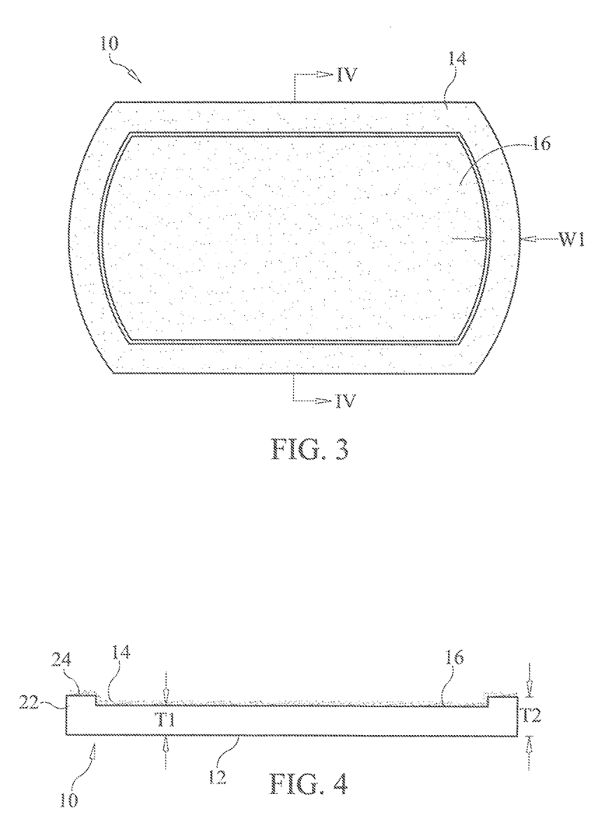

Therefore, an embodiment of the present invention is described herein and illustrated in FIG. 1, wherein like numerals refer to like parts. FIG. 1 illustrates an apparatus 10 in an embodiment of the present invention. The apparatus 10 may have a first side 12 and a second side 14 (as illustrated in FIG. 3). The apparatus 10 may be made from stone, ceramic, clay, fire clay, or other like materials known to one having ordinary skill in the art. Moreover, the apparatus 10 may include additives to strengthen the apparatus 10 when fired or hardened; such as, for example, spodumene, a lithium aluminum silicate, or other lithium-based minerals that may provide thermal protection to the apparatus 10, especially if exposed to high temperatures. Preferably, 2.5% by weight spodumene may be added to a clay mixture to thermally protect and strengthen the clay when hardened.

The apparatus 10 may be, preferably, a slab having, generally, a constant thickness throughout (except for the location of a surface 16 illustrated in FIG. 3) to maintain a constant temperature throughout the grilling apparatus when disposed over a heat source, such as a fire or other heating source. The first side 12 may include a first surface for grilling or otherwise cooking food products thereon. The first surface may be relatively smooth, and may be useful to utilize as a cooking surface such that food products cooked thereon have a tendency to be removable from the first surface without sticking of the food product to the first surface.

The apparatus 10 may be sized so as to fit most modern grills. Preferably, the apparatus 10 may be between about 8 inches and about 17 inches long, measured at the apex of each arcuate portion of the grilling apparatus, as shown in FIGS. 1-3 and described below. More preferably, the apparatus 10 may be between about 10 inches and about 15 inches long. Most preferably, the apparatus 10 may be about 13 inches long. In addition, the apparatus 10 may preferably be between about 5 inches wide and 13 inches wide. More preferably, the apparatus 10 may be between about 7 inches and 11 inches wide. Most preferably, the apparatus 10 may be about 9 inches wide.

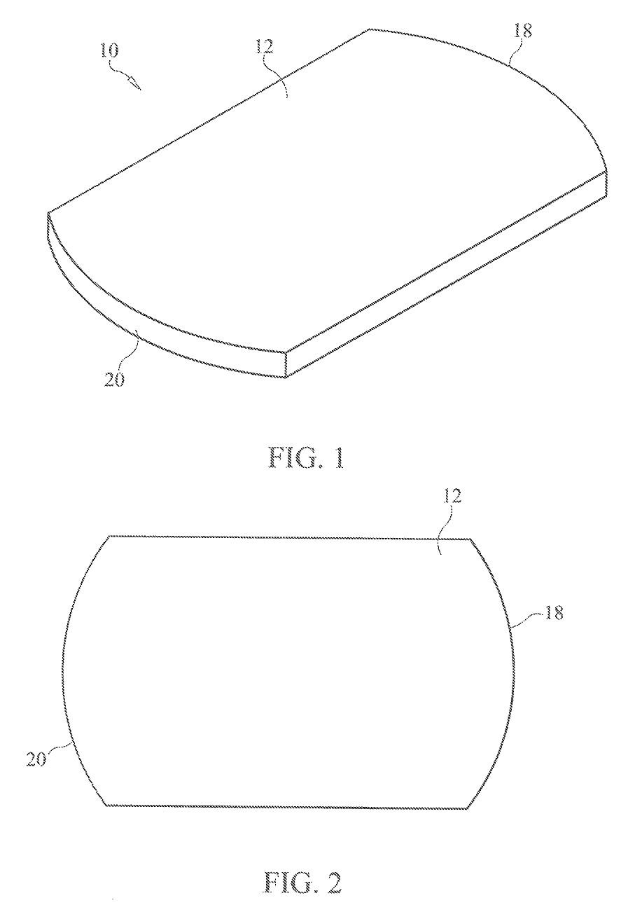

As illustrated in FIGS. 1 and 2, the apparatus 10 may be generally rectangular in shape having sufficient area to provide a cooking surface for most food products to be cooked thereon. The apparatus 10 may include a first edge 18 and a second edge 20. At least one of the first edge 18 and the second edge 20 may be arcuate is shape. Providing an arcuate portion may extend the area of the cooking surface and may reduce the sharpness of the corners of the apparatus 10. It is believed that providing the arcuate portion along one or more of the edges thereby allows convection heat to more easily rise around the edges of the apparatus 10, thereby providing better indirect heating of the food products contained thereon. Indirect heating may be useful for more evenly cooking food products cooked thereon and for, potentially, browning of the top surface of the food product or otherwise “finishing” the cooking of the food product. This may be particularly useful for food products that are not turned over, but cooked throughout and disposed on only one side throughout the cooking process.

FIG. 3 illustrates a plan view of a second side 14 of the apparatus 10. The second side 14 may include a surface 16 that is textured to be rough. The texture may preferably be a plurality of pits, bumps, valleys, troughs, peaks and other like textural features disposed preferably over the entirety of the second surface of the second side 14 or otherwise within discrete sections, portions or areas of the surface 16 on the second side 14. The texture may provide the ability to allow heat to easily spread under a food product disposed thereon aiding in the cooking of the food product. The texture may also increase the surface area of the second surface 16, allowing heated air to contact the food product disposed thereon, thereby potentially decreasing burning of the food product when the second surface is heated.

An additional advantage of the texture disposed over the surface 16 may be to allow for the retention of water and/or oil to act as cooking media for the food product cooked thereon. For example, a liquid cooking medium of water may be poured onto the surface 16 before and/or during the cooking of a food product. The water may become entrapped within the textural features disposed over the surface 16. Foods cooked thereon may, effectively, be steamed when the apparatus 10 is disposed over a heat source.

Moreover, a liquid cooking medium of cooking oil may be poured onto the second surface before and/or during the cooking of a food product. The oil may become entrapped within the textural features disposed throughout the surface 16. Foods cooked thereon may, effectively, be fried when the apparatus 10 is disposed over a heat source.

In addition, foods may be cooked without the addition of water and/or oils. Water and/or oils may come from the food product itself cooked on the apparatus 10. The textured surface may allow the water and/or oils to become entrapped at the location of the food product thereby aiding in the cooking of the food product. Alternatively, sauces may be disposed over the food products, and the textural features may aid in retaining the sauces in the location of the food product cooked thereon.

The surface 16 is further shown in FIG. 4, which is a cross-sectional view of the apparatus 10 along line IV-IV of FIG. 3. The second side 14 may further include a raised portion 22 disposed around the perimeter or outside edge of the second side 14 of the apparatus 10. The apparatus 10 may have a thickness T1 between the surface 16 and the first side 12. Preferably, the thickness T1 may be constant between the surface 16 and the first side 12 over the entirety of the apparatus 10, although the invention should not be limited in this regard. In addition, the raised portion 22 may have a thickness T2 between a top surface 24 of the raised portion 18 and the first side 12.

Preferably, the thicknesses T1 and T2 may be between about ¼ inch and about 1 inch. More preferably, the thicknesses T1 and T2 may be between about ½ inch to about ⅝ inch. Most preferably, the thicknesses T1 and T2 may have a thickness of about ¼ inch, although the thickness T1 of the raised portion 22 is greater than the thickness T2 between the surface 16 and the first side 12. Specifically, the difference in the thicknesses between T1 and T2 may be between about 1/32 inch and about ⅛ inch. More preferably, the difference in the thicknesses between T1 and T2 may be between about 1/16 inch and about 3/32 inch.

The apparatus 10 may be relatively thin so that the apparatus 10 may heat quickly for even distribution of the heat source throughout the grilling apparatus. However, the apparatus 10 may also be made from a resilient and durable material that will not crack when heated over a heating source.

The surface 16 is shown having, generally, the same geometric shape as the apparatus 10, but disposed equidistant from the edges of the apparatus 10 to allow the food product to be disposed as close as possible to the edges of the apparatus 10 at all locations on the second side 14 of the apparatus 10 to be heated by indirect convection heat sources that rise around the edges of the apparatus 10. However, it should be noted that the surface 16 may be any shape apparent to those having ordinary skill in the art and the invention should not be limited as described herein. Preferably, the raised portion 22 may have a width W1, as shown in FIG. 3, between the outside edge of the second side and the surface 16. Preferably, the width W1 is constant between the outside edge of the second side and the surface 16 at all locations around the second side 14. Specifically, the width W1 may be between about ½ inch and about 1½ inches between the outside edge of the second side 14 and the surface 16, although the invention should not be limited as herein described. Most preferably, the width W1 may be about ¾ inch from the outside edge of the second side 14.

The difference in thicknesses T1 and T2, as illustrated in FIGS. 3 and 4, may preferably be enough to provide for the retention of water, oils, sauces, the food product, or other like material on the surface 16, but generally does not overly effect the overall thickness of the apparatus 10.

Moreover, the apparatus 10 is shown as having, generally, a constant thickness between the surface 16 and the first side 12 over the entirety of the apparatus 10 to provide an even heating surface, although the invention should not be limited in this regard. As illustrated in FIG. 4, the textured features may be disposed on the surface 16 to provide the advantages thereof for the food products cooked therein. Although the textured features are shown on the surface 24 of the raised portion 22 of the second side 14 of the grilling apparatus 10, the invention should not be limited as herein described, as the surface 24 of the raised portion 22 may be smooth, while the surface 16 may have the textured features as described above.

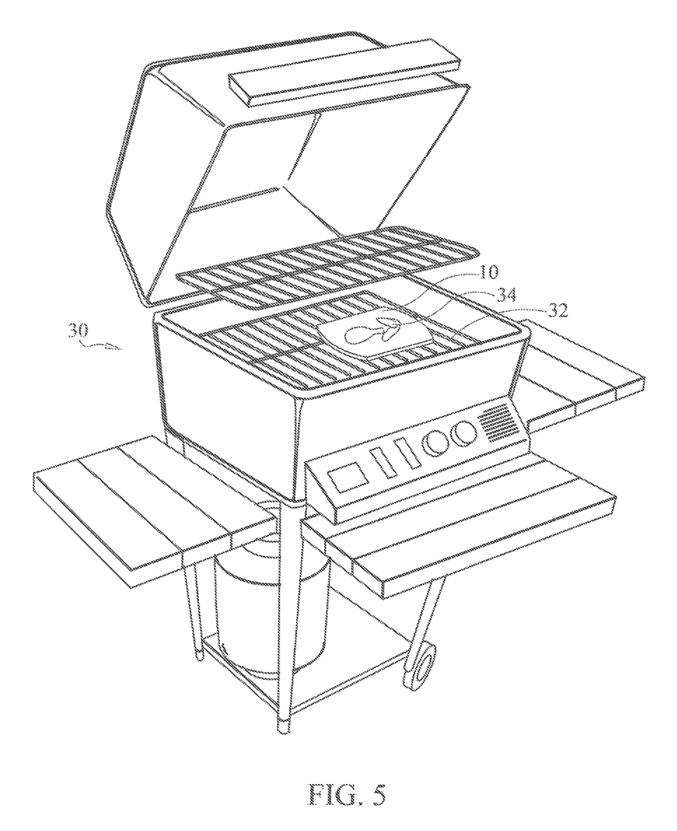

FIG. 5 illustrates the apparatus 10, as described herein, disposed within a grill 30 on a grill rack 32 on which a food product 34 may be disposed for cooking. The apparatus 10 may be heated by the heat source provided within the grill, whether by charcoal, gas, or other heat source. Alternatively, the apparatus may be disposed over flames of a stove-top, or may be placed within an oven. If the grill is a smaller, round grill, the arcuate portions of the sides of the apparatus 10 may allow the apparatus 10 to fit neatly within the round grill, thereby allowing the remainder of the grill rack to be utilized for the cooking of other food products, such as meats and the like.

In a method of using the apparatus 10 of the present invention, the apparatus 10 may be placed on the grill 30, whereupon the surface of the apparatus 10 and the grill rack 32 may be utilized for the cooking of food. Food is then placed on the top surface of the apparatus 10. The top surface may either be the smooth side of the apparatus 10 or the textured side having the raised portion around the outside edge of the apparatus 10. The apparatus 10 may be heated, either prior to adding the food to the apparatus 10 or after the food is disposed on the apparatus 10. The food may then be cooked thoroughly. Alternatively, the apparatus 10 may be disposed such that the textured side with the raised portion around the outside edge is the top surface, and a liquid cooking medium may be added with the food, either prior or after disposing the food on the apparatus 10. The liquid cooking medium, which may be water or cooking oil, may aid in cooking the food contained thereon.

The grill rack may be utilized to provide a location to sear the food products over the high heat generated by the grill, such as meat and the like for disposing grill lines in the food products. Then the food product may be disposed on the apparatus 10 for thorough and controlled cooking of the food product. Alternatively, a food product may be cooked on the apparatus 10 first, followed by searing of the food product on the grill rack to provide the grill lines.

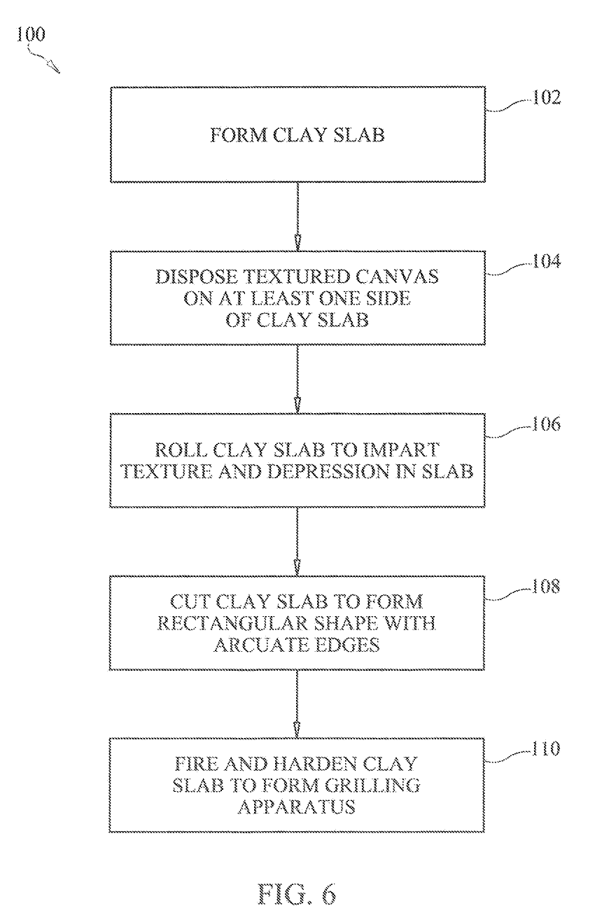

FIG. 6 illustrates a flow chart 100 of a preferred method of making the apparatus 10 of the present invention. Specifically, in a first step 102, a malleable clay slab may be created. Typically, wet clay may be formed into a general slab shape to be formed into the apparatus 10, as discussed below. After the wet clay slab is formed, a textured canvas may be disposed on either one or both surfaces of the clay slab via step 104. The textured canvas may act as a textured template that imparts the texture of the canvas to the clay slab when pressed. The clay slab may then be rolled to a constant thickness via step 106. Moreover, disposed on the roller may be a template that presses the depression into the clay slab, as described above with respect to FIGS. 3 and 4. Moreover, rolling the clay slab may further impart the texture from the canvas into one or both of the surfaces of the clay slab.

The clay slab, having been rolled to a desired thickness, having had the texture imparted thereon, and having the depression pressed thereinto, may be cut into the generally rectangular shape with arcuate edges via step 108. The cutting may be accomplished according to any method apparent to one having ordinary skill in the art, and may include hand-cutting or machine-cutting the clay slab to form the generally rectangular shape with the arcuate edges. Alternatively, if the textured features are disposed in both surfaces of the slab, and only one textured surface may be desired with the other surface being smooth, one of the surfaces may be wiped of its texture prior to being fired. Finally, in step 110, the clay slab may be fired at high temperatures as apparent to one having ordinary skill in the art to harden the slab to form the apparatus 10, as described above.

The apparatus 10 may preferably be resilient to withstand high temperatures associated with grilling and otherwise cooking foods, such as on a grill, on a stove-top, or in an oven. For example, a grill may typically reach temperatures between about 200 degrees F. and 600 degrees F., if not higher. Preferably, the apparatus 10 may be utilized at typical cooking temperatures of between 300 and 400 degrees F. Moreover, the apparatus 10 should further withstand the pouring of water and/or oils onto the apparatus 10, as described above, even at high temperatures, and should not crack, split, shatter or the like when in use. The apparatus 10 can be cleaned and sterilized by exposure to high temperatures such as temperatures from charcoal and/or propane grills. Exposure to high temperatures may further remove odors and prevent residual tastes to be imparted to foods subsequently cooked thereon.

In addition, the apparatus 10 may further include a lid for disposing over foods cooked thereon. The lid may be sized and shaped to fit over the surface 16, such that the lid fits within the boundaries defined by the raised portion 22 to create a sealed enclosure when disposed on the apparatus 10. Alternatively, the lid may be smaller or bigger than the surface 16, as apparent to one having ordinary skill in the art.

It should be understood that various changes and modifications to the presently preferred embodiments described herein will be apparent to those skilled in the art. Such changes and modifications may be made without departing from the spirit and scope of the present invention and without diminishing its attendant advantages.

I claim:

1. An apparatus for cooking food thereon, the apparatus comprising:
a slab made of hardened clay having a first end and a second end, a first side having a first surface and a second side having a second surface wherein the second surface has a texture of bumps and pits, and wherein the slab has a thickness between the first surface and the second surface, and
further wherein the slab has a raised portion disposed about an outside edge of the second side wherein the raised portion has a top surface and further wherein the raised portion has a thickness between the top surface of the raised portion and the first surface of the first side, wherein the thickness between the top surface of the raised portion and the first surface is greater than the thickness between the first surface and the second surface.

2. The apparatus of claim 1 wherein the first end is arcuate in shape.

3. The apparatus of claim 1 wherein the first end and the second end are arcuate in shape.

4. The apparatus of claim 1 wherein the thickness between the first surface and the second surface is constant over the entirety of the slab.

5. The apparatus of claim 1 wherein the top surface of the raised portion has a width measured from the outside edge of the second side to the second surface, wherein the width of the top surface of the raised portion is constant over the entirety of the slab between the outside edge of the second side to the second surface.

6. The apparatus of claim 1 wherein the thickness between the first surface and the second surface is between about ¼ inch and about 1 inch.

7. The apparatus of claim 1 wherein the difference in the thickness of the raised portion and the thickness between the first surface and the second surface is between about 1/32 inch and about ⅛ inch.

8. A system for cooking food comprising:
a hardened clay slab for cooking food thereon comprising a first side having a first surface, a second side having a depression for holding food products therein, wherein the depression has a bottom surface and said bottom surface has a texture of pits and bumps, and a thickness between the first side and the second side; and
a heating device wherein the apparatus is disposed on the heating device.

9. The system of claim 8 wherein the heating device is selected from the group consisting of a grill, an oven, or a stove-top.

10. The system of claim 8 wherein the slab further comprises a first end wherein the first end is arcuate in shape.

11. The system of claim 8 wherein the slab further comprises a first end and a second end wherein the first end and the second end are both arcuate in shape.

12. The system of claim 8 wherein the depression of the slab has a depth wherein the depth of the depression is constant over the entirety of the depression.

13. The system of claim 8 wherein the slab has a thickness of between about ¼ inch and about 1 inch.

14. The system of claim 8 wherein the depression has a depth between about 1/32 inch and about ⅛ inch.

15. A method of using an apparatus for cooking food comprising the steps of:
providing a slab made of hardened clay having a first end and a second end, a first side having a first surface and a second side having a second surface wherein the second surface has a texture of bumps and pits, and wherein the slab has a thickness between the first surface and the second surface, and further wherein the slab has a raised portion disposed about an outside edge of the second side wherein the raised portion has a top surface and further wherein the raised portion has a thickness between the top surface of the raised portion and the first surface of the first side, wherein the thickness between the top surface of the raised portion and the first surface is greater than the thickness between the first surface and the second surface;
disposing a food product on a side selected from the group consisting of the first side and the second side;
disposing a heat source beneath the slab; and
cooking the food product on the slab.

16. The method of claim 15 wherein the food product is disposed on the second surface.

17. The method of claim 15 further comprising the steps of:
adding a liquid cooking medium to the second surface; and
disposing a food product on the second surface in the liquid cooking medium.

18. The method of claim 15 further comprising the steps of:
adding a liquid cooking medium to the depression of the second side, wherein the cooking medium is selected from the group consisting of water and oil; and
disposing a food product on the second surface in the liquid cooking medium.

19. The method of claim 15 wherein the heat source is selected from the group consisting of a grill, an oven and a stove-top.

20. The method of claim 15 further comprising the step of:
providing a lid; and
disposing the lid over the food product when cooking the food product.
